(19) United States
(12) Patent Application Publication
(10) Pub. No.: US 2026/0279384 A1
(43) Pub. Date: Sep. 17, 2026

(54) EMOTION FILTERING SYSTEM

(71) Applicant: SoftBank Group Corp., Tokyo (JP)

(72) Inventor: Makoto AOTO, Tokyo (JP)

(21) Appl. No.: 19/564,234

(22) Filed: Mar. 12, 2026

Related U.S. Application Data
(60) Provisional application No. 63/771,007, filed on Mar. 13, 2025.

(51) Int. Cl. G10L 25/63; G06F 40/30; G10L 15/26; G10L 21/013; G10L 21/043

(52) U.S. Cl. CPC G10L 25/63; G06F 40/30; G10L 15/26; G10L 21/013; G10L 21/043; G10L 2021/0135

(57) ABSTRACT

This system acquires voice data in real time with an acquisition unit and converts the voice into text with a conversion unit. An emotion recognition unit analyzes the text data and classifies emotions into positive, neutral, and negative. When a negative emotion is detected, a filtering unit adjusts the tone and pitch of the voice and converts it into a rational voice. Furthermore, a generation unit omits or summarizes irrelevant utterances and extracts only important information. An output unit provides the filtered and generated voice to a user, enabling the conversation to be continued in a form with reduced stress.

### CROSS-REFERENCE TO RELATED APPLICATION

This application claims the benefit of priority from U.S. Provisional Patent Application No. 63/771,007, filed on Mar. 13, 2025. The entire contents of the priority application are incorporated herein by reference.

### BACKGROUND

The technology of the present disclosure relates to a system.

Japanese Unexamined Patent Application Publication No. 2022-180282 discloses a method, which is a persona chatbot control method performed by at least one processor, the method including a step of receiving a user utterance, a step of adding the user utterance to a prompt including an instruction sentence associated with a description regarding a character of a chatbot, a step of encoding the prompt, and a step of inputting the encoded prompt to a language model to generate a chatbot utterance responding to the user utterance.

### SUMMARY

The problem to be solved by this disclosure is that emotional voices and negative utterances in online calls cause stress to a recipient and reduce work efficiency. Particularly, in the modern era where remote work and online meetings are increasing, emotional voices and negative utterances heard directly in the ear are factors that diminish the recipient's concentration and increase psychological burden. Such a situation not only significantly reduces work productivity but also has the potential to worsen the atmosphere of the entire work environment.

Furthermore, when negative utterances are irrelevant to the main thread of a discussion, responding or reacting to them leads to a waste of time and further reduces the efficiency of the meeting. This disclosure aims to provide an environment where a recipient can concentrate on work without feeling stress by using emotion recognition AI and voice filtering technology to convert emotional voices into rational voices and to omit or summarize negative utterances. This makes it possible to reduce the negative impact during online calls and improve work efficiency.

As a means for solving the problem, the present disclosure provides a system that acquires voice data during an online call in real time and effectively processes emotional voices and negative utterances. This system includes an acquisition unit that acquires voice data, and collects voice during an online call in a digital format. The acquired voice data is converted into text data by a conversion unit using speech recognition technology.

The converted text data is analyzed by an emotion recognition unit, which classifies emotions by fully utilizing natural language processing technology. This emotion recognition unit classifies emotions into three categories: positive, neutral, and negative, and responds particularly when a negative emotion is detected.

A filtering unit adjusts the tone, pitch, and speed of voice data for which a negative emotion has been detected, and converts it into a rational voice with suppressed emotional elements. Through this process, a voice with reduced stress is provided to the recipient.

Furthermore, when it is determined that a negative utterance is irrelevant to the main thread of a discussion, a generation unit omits or summarizes the utterance using a generative AI. This prevents a waste of time due to irrelevant utterances and improves the efficiency of the meeting.

Finally, an output unit provides the filtered and generated voice to a recipient, making it possible to reduce the negative impact during online calls and improve work efficiency. In this way, the present disclosure provides a means for effectively solving the problem of reduced work efficiency due to emotional voices and negative utterances in online calls.

### BRIEF DESCRIPTION OF DRAWINGS

FIG. 1 is a conceptual diagram illustrating an example of a configuration of a data processing system according to a first embodiment.

FIG. 2 is a conceptual diagram illustrating an example of main functions of a data processing apparatus and a smart device according to the first embodiment.

FIG. 3 is a conceptual diagram illustrating an example of a configuration of a data processing system according to a second embodiment.

FIG. 4 is a conceptual diagram illustrating an example of main functions of a data processing apparatus and smart glasses according to the second embodiment.

FIG. 5 is a conceptual diagram illustrating an example of a configuration of a data processing system according to a third embodiment.

FIG. 6 is a conceptual diagram illustrating an example of main functions of a data processing apparatus and a headset-type terminal according to the third embodiment.

FIG. 7 is a conceptual diagram illustrating an example of a configuration of a data processing system according to a fourth embodiment.

FIG. 8 is a conceptual diagram illustrating an example of main functions of a data processing apparatus and a robot according to the fourth embodiment.

FIG. 9 illustrates an emotion map on which a plurality of emotions are mapped.

FIG. 10 illustrates an emotion map on which a plurality of emotions are mapped.

FIG. 11 is a flowchart illustrating an example of a method for filtering emotions.

### DETAILED DESCRIPTION

Hereinafter, an example of an embodiment of a system according to the technology of the present disclosure will be described with reference to the accompanying drawings.

First, terms used in the following description will be described.

In the following embodiments, a processor with a reference sign (hereinafter, simply referred to as a “processor”) may be one arithmetic device or may be a combination of a plurality of arithmetic devices. Also, the processor may be one type of arithmetic device or may be a combination of a plurality of types of arithmetic devices. Examples of the arithmetic device include a CPU (Central Processing Unit), a GPU (Graphics Processing Unit), a GPGPU (General-Purpose computing on Graphics Processing Units), an APU (Accelerated Processing Unit), and the like.

In the following embodiments, a RAM (Random Access Memory) with a reference sign is a memory in which information is temporarily stored, and is used as a work memory by a processor.

In the following embodiments, a storage with a reference sign is one or more non-volatile storage devices that store various programs, various parameters, and the like. Examples of the non-volatile storage device include a flash memory (SSD (Solid State Drive)), a magnetic disk (for example, a hard disk), or a magnetic tape, and the like.

In the following embodiments, a communication I/F (Interface) with a reference sign is an interface including a communication processor, an antenna, and the like. The communication I/F manages communication among a plurality of computers. An example of a communication standard applied to the communication I/F includes a wireless communication standard including 5G (5th Generation Mobile Communication System), Wi-Fi (registered trademark), or Bluetooth (registered trademark), and the like.

In the following embodiments, “A and/or B” is synonymous with “at least one of A and B”. That is, “A and/or B” means that it may be A only, B only, or a combination of A and B. Also, in the present specification, when three or more matters are expressed by being connected with “and/or”, the same concept as “A and/or B” is applied.

### First Embodiment

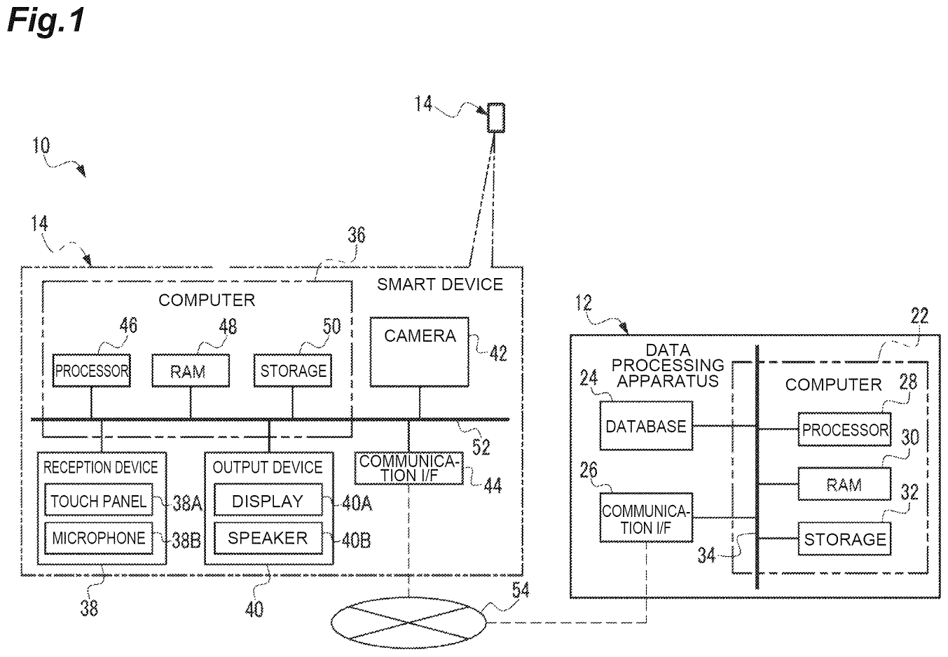

FIG. 1 illustrates an example of a configuration of a data processing system 10 according to a first embodiment.

As illustrated in FIG. 1, the data processing system 10 includes a data processing apparatus 12 and a smart device 14. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The smart device 14 includes a computer 36, a reception device 38, an output device 40, a camera 42, and a communication I/F 44. The computer 36 includes a processor 46, a RAM 48, and a storage 50. The processor 46, the RAM 48, and the storage 50 are connected to a bus 52. Also, the reception device 38, the output device 40, and the camera 42 are also connected to the bus 52.

The reception device 38 includes a touch panel 38A, a microphone 38B, and the like, and receives a user input. The touch panel 38A receives a user input by contact of an indicator by detecting contact of the indicator (for example, a pen or a finger, etc.). The microphone 38B receives a user input by voice by detecting a user's voice. A control unit 46A transmits data indicating the user input received by the touch panel 38A and the microphone 38B to the data processing apparatus 12. In the data processing apparatus 12, a specific processing unit 290 acquires the data indicating the user input.

The output device 40 includes a display 40A, a speaker 40B, and the like, and presents data to a user 20 by outputting the data in a representation form (for example, voice and/or text) perceivable by the user 20. The display 40A displays visible information such as text and images in accordance with an instruction from the processor 46. The speaker 40B outputs voice in accordance with an instruction from the processor 46. The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted.

The communication I/F 44 is connected to the network 54. The communication I/Fs 44 and 26 manage exchange of various information between the processor 46 and the processor 28 via the network 54.

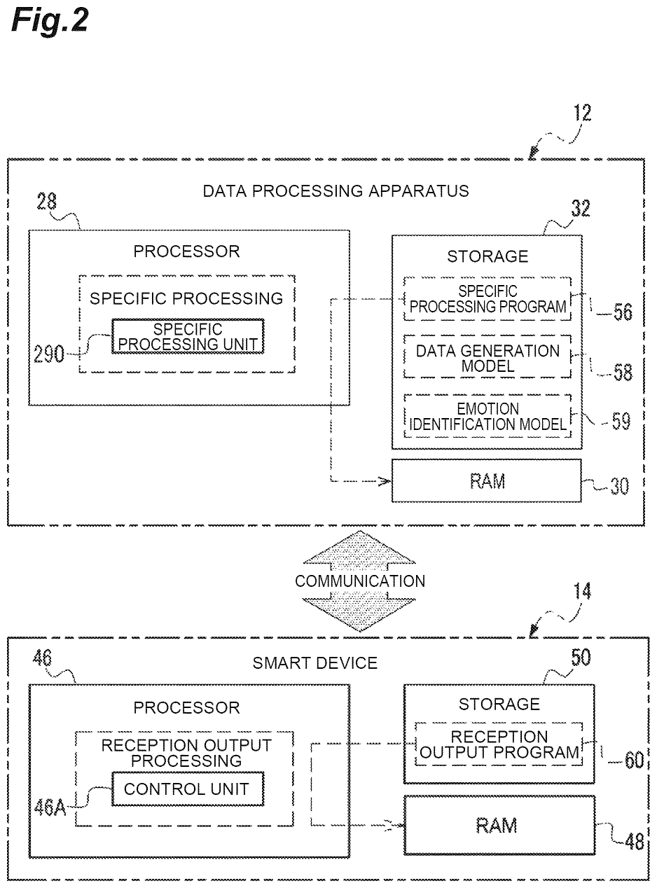

FIG. 2 illustrates an example of main functions of the data processing apparatus 12 and the smart device 14.

As illustrated in FIG. 2, in the data processing apparatus 12, specific processing is performed by the processor 28. A specific processing program 56 is stored in the storage 32. The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as a specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290. The specific processing unit 290 can estimate a user's emotion using the emotion identification model 59 and perform specific processing using the user's emotion. In an emotion estimation function (emotion identification function) using the emotion identification model 59, various estimations and predictions regarding the user's emotion, including estimation and prediction of the user's emotion, are performed, but the present disclosure is not limited to such an example. Also, the estimation and prediction of emotion include, for example, analysis (analytics) of emotion and the like.

Furthermore, the processor 28 may be configured to include, in addition to a general-purpose CPU, a DSP (Digital Signal Processor) specialized for audio signal processing or an NPU (Neural Processing Unit) specialized for neural network processing. The filtering processing of the audio data by the specific processing unit 290 is executed using a ring buffer secured in the RAM 30. The audio data acquired by the acquisition unit is packetized for each predetermined frame length (for example, 10 ms to 20 ms) and temporarily stored in the ring buffer. The filtering unit and the generation unit execute spectral transformation and resynthesis processing, which will be described later, on the data in this ring buffer in real time (for example, within a delay time of 200 ms), and transmit the processed data via the communication I/F 26. This makes it possible to modulate only the emotional voice components at the physical signal level without impairing the interactivity in the online call.

In the smart device 14, reception output processing is performed by the processor 46. A reception output program 60 is stored in the storage 50. The reception output program 60 is used in combination with the specific processing program 56 by the data processing system 10. The processor 46 reads the reception output program 60 from the storage 50 and executes the read reception output program 60 on the RAM 48. The specific processing is realized by the processor 46 operating as a control unit 46A in accordance with the specific processing program 60 executed on the RAM 48. Note that the smart device 14 can also have a data generation model and an emotion identification model similar to the data generation model 58 and the emotion identification model 59, and perform processing similar to that of the specific processing unit 290 using these models. The reception output processing is realized by the processor 46 operating as the control unit 46A in accordance with the reception output program 60 executed on the RAM 48.

Note that an apparatus other than the data processing apparatus 12 may have the data generation model 58. For example, a server apparatus (for example, a generation server) may have the data generation model 58. In this case, the data processing apparatus 12 obtains a processing result (such as a prediction result) in which the data generation model 58 is used, by communicating with the server apparatus having the data generation model 58. Also, the data processing apparatus 12 may be a server apparatus, or may be a terminal device owned by a user (for example, a mobile phone, a robot, a home appliance, etc.). Next, an example of processing by the data processing system 10 according to the first embodiment will be described.

### Example 1

A flow of specific processing in Example 1 will be described. Each unit of the system described below is realized by the data processing apparatus 12 and the smart device 14. Also, the data processing apparatus 12 is referred to as a “server”, and the smart device 14 is referred to as a “terminal”.

### Embodiment

An embodiment will be described in more specific and detailed terms regarding a system configuration using a server and a terminal.

First, an acquisition unit that acquires voice data during an online call is implemented on a terminal used by a user. The acquisition unit may be configured by, for example, the reception device 38. This terminal can be a variety of devices such as a desktop computer, a laptop computer, a smartphone, or a tablet. These terminals are usually equipped with a built-in microphone, but it is also possible to connect an external microphone or a headset. For example, in a business meeting, clearer voice data can be acquired by using a high-quality external microphone.

The acquired voice data is converted into text data by speech recognition software operating on the terminal. This conversion unit analyzes a voice waveform, identifies phonemes, and converts the voice into a character string using a language model. The conversion unit may be constituted by, for example, the computer 36 or the processor 46. The speech recognition software supports multiple languages and can be used in international meetings. Also, since it can convert voice to text in real time, it can perform processing without interrupting the flow of conversation. Furthermore, the speech recognition software is provided with a noise canceling function, and can remove background noise and accurately recognize a speaker's voice.

The converted text data is transmitted to a server via the Internet. An emotion recognition unit is implemented on the server and analyzes emotions in the text by fully utilizing natural language processing technology. The emotion recognition unit may be configured by, for example, the specific processing unit 290 and the emotion identification model 59. This emotion recognition unit classifies emotions from the text data into one of positive, neutral, and negative using a machine learning algorithm. For example, the emotion recognition AI determines emotions by also taking into consideration word choice, context, grammatical structure, and even the frequency of use of pictograms and exclamation marks.

When a negative emotion is detected, a filtering unit on the server performs processing on the voice data. The emotion recognition unit may be configured by, for example, the specific processing unit 290, the emotion identification model 59, and the data generation model 58. This filtering unit uses voice synthesis technology to adjust the tone, pitch, and speed of the voice, and converts it into a rational voice with suppressed emotional elements. For example, while maintaining the speaker's voice quality, the intonation of the voice can be flattened and the speed can be made constant in order to reduce the intensity of the emotion. Also, when a specific emotional phrase is detected, it is also possible to automatically replace that part.

Furthermore, when it is determined that a negative utterance is irrelevant to the main thread of a discussion, a generation unit on the server omits or summarizes the utterance. The generation unit may be configured by, for example, the specific processing unit 290, the emotion identification model 59, and the data generation model 58. This generation unit analyzes the content of the utterance and evaluates its importance. For example, the generative AI evaluates the importance by also performing a comparison with past meeting logs, in addition to the length of the utterance, the frequency of keyword appearance, and the relevance in the context. An utterance determined to have low importance is deleted from the voice or presented in a summarized form.

Finally, the filtered and generated voice data is transmitted from the server to the terminal and provided to the user through an output unit. The output unit may be configured by, for example, the output device 40. For example, through the terminal's speaker or headset, the user can receive the voice with reduced stress. Furthermore, a user interface has a function to display the results of filtering and summarization in real time, and the user can provide feedback as needed. In this way, the present disclosure provides a means for effectively solving the problem of reduced work efficiency due to emotional voices and negative utterances in online calls.

### (System Configuration)

The system according to the present embodiment includes an acquisition unit, a conversion unit, an emotion recognition unit, a filtering unit, a generation unit, and an output unit. The acquisition unit is responsible for acquiring voice data during an online call in real time. This acquisition unit is implemented on a terminal used by a user, and devices such as a desktop computer, a laptop computer, a smartphone, or a tablet are conceivable. These terminals are usually equipped with a built-in microphone, but it is also possible to connect an external microphone or a headset. For example, in a business meeting, clearer voice data can be acquired by using a high-quality external microphone. Also, by using a microphone equipped with a noise canceling function, it is possible to remove background noise and accurately acquire a speaker's voice.

The conversion unit converts the acquired voice data into text data. This conversion unit is realized by speech recognition software operating on the terminal, analyzes a voice waveform, identifies phonemes, and converts the voice into a character string using a language model. For example, the speech recognition software supports multiple languages and can be used in international meetings. Also, since it can convert voice to text in real time, it can perform processing without interrupting the flow of conversation.

The emotion recognition unit analyzes the converted text data and classifies emotions by fully utilizing natural language processing technology. This emotion recognition unit is implemented on a server and classifies emotions from the text data into one of positive, neutral, and negative using a machine learning algorithm. For example, the emotion recognition AI determines emotions by also taking into consideration word choice, context, grammatical structure, and even the frequency of use of pictograms and exclamation marks. Also, by learning from past conversation data, it can grasp the emotional tendencies of a specific speaker and realize more accurate emotion recognition.

A specific algorithm for the analysis processing in the emotion recognition unit will be described in detail. The emotion recognition unit tokenizes the converted text data and inputs it into a pre-trained language model (for example, a Transformer-based model) to generate a contextual embedding vector for each token. Next, the emotion recognition unit applies an attention mechanism to the generated vectors to calculate a weighting score that identifies which words in the sentence contribute strongly to the emotional polarity. Based on this weighting score, a probability value (Confidence Score) that the input utterance is “negative” is calculated. Only when this probability value exceeds a predetermined threshold (for example, 0.75), a trigger signal for the filtering processing described later is generated. In this way, by performing determination based on mathematical vector operations and threshold processing, objective and quantitative emotion classification that does not depend on human subjectivity is realized.

The filtering unit performs processing on the voice data when a negative emotion is detected. This filtering unit uses voice synthesis technology to adjust the tone, pitch, and speed of the voice, and converts it into a rational voice with suppressed emotional elements. For example, while maintaining the speaker's voice quality, the intonation of the voice can be flattened and the speed can be made constant in order to reduce the intensity of the emotion. Also, when a specific emotional phrase is detected, it is also possible to automatically replace that part. Furthermore, it provides an interface that allows the user to adjust the degree of filtering, and realizes voice output according to individual needs.

The voice conversion processing by the filtering unit is executed by the following specific signal processing steps. First, the filtering unit performs a Fast Fourier Transform (FFT) on the voice frame determined to be negative to acquire a frequency spectrum. Next, a fundamental frequency (pitch) and formant frequencies are extracted from the acquired spectrum. The filtering unit dynamically generates and applies filter coefficients that smooth the spectral envelope so that the power of high-frequency components indicating an emotional excitement state is suppressed. Furthermore, the pitch contour is flattened using a waveform synthesis technique such as the PSOLA (Pitch Synchronous Overlap and Add) method so that the fluctuation width (jitter) of the pitch falls within a predetermined range. Finally, an Inverse Fast Fourier Transform (IFFT) is performed to restore the voice signal in the time domain. Through this series of signal processing, a “rational voice” in which only the emotional components are physically removed while maintaining the speaker's individuality (voice quality) is generated.

The generation unit omits or summarizes a negative utterance when it is determined to be irrelevant to the main thread of a discussion. This generation unit is implemented on a server, analyzes the content of the utterance, and evaluates its importance. For example, the generative AI evaluates the importance by also performing a comparison with past meeting logs, in addition to the length of the utterance, the frequency of keyword appearance, and the relevance in the context. An utterance determined to have low importance is deleted from the voice or presented in a summarized form. Specific examples of prompt sentences to be read into the generative AI include, “Evaluate how relevant this utterance is to the purpose of the meeting, and summarize it if the relevance is low,” and “Extract the important points of this utterance and summarize them concisely.”

The determination of “relevance to the main thread of the discussion” and the summarization processing in the generation unit are executed by the following logic. The generation unit holds a “context vector” summarizing the conversation history from the start of the meeting to the present in a memory. When a new negative utterance is detected, the generation unit vectorizes the utterance and calculates a cosine similarity with the context vector. If the calculated similarity falls below a predetermined relevance threshold, the utterance is determined to be “noise (irrelevant to the discussion).” If determined to be noise, the generation unit blocks (mutes) the transmission of the voice packet of the utterance, or converts it into text extracting only the intent of the utterance (e.g., “The speaker is expressing concern about the progress”) using generative AI and reads it out by voice synthesis. This achieves the technical effect of preventing waste of network bandwidth due to irrelevant emotional utterances and reducing the cognitive load on the recipient.

The output unit is responsible for providing the filtered and generated voice data to the user. For example, through the terminal's speaker or headset, the user can receive the voice with reduced stress. Furthermore, a user interface has a function to display the results of filtering and summarization in real time, and the user can provide feedback as needed. In this way, the system according to the present embodiment provides a means for effectively solving the problem of reduced work efficiency due to emotional voices and negative utterances in online calls.

### (Implementation Steps)

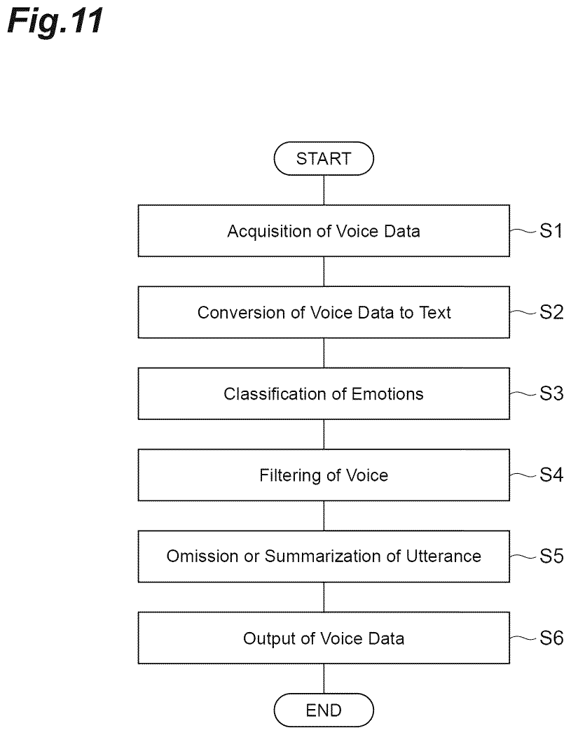

### Step 1: Acquisition of Voice Data. (See Step S1 in FIG. 11)

Voice data during an online call is acquired in real time. In this step, an acquisition unit implemented on a terminal used by a user collects voice through devices such as a desktop computer, a laptop computer, a smartphone, or a tablet. The terminal is equipped with a built-in microphone, but it is also possible to connect an external microphone or a headset. For example, in a business meeting, clearer voice data can be acquired by using a high-quality external microphone. Also, by using a microphone equipped with a noise canceling function, it is possible to remove background noise and accurately acquire a speaker's voice.

### Step 2: Conversion of Voice Data to Text. (See Step S2 in FIG. 11)

The acquired voice data is converted into text data. In this step, speech recognition software operating on the terminal analyzes a voice waveform, identifies phonemes, and converts the voice into a character string using a language model. The speech recognition software supports multiple languages and can be used in international meetings. Also, since it can convert voice to text in real time, it can perform processing without interrupting the flow of conversation.

### Step 3: Classification of Emotions. (See Step S3 in FIG. 11)

The converted text data is analyzed and emotions are classified. In this step, an emotion recognition unit implemented on a server classifies emotions in the text into one of positive, neutral, and negative by fully utilizing natural language processing technology. The emotion recognition AI determines emotions by also taking into consideration word choice, context, grammatical structure, and even the frequency of use of pictograms and exclamation marks. Also, by learning from past conversation data, it can grasp the emotional tendencies of a specific speaker and realize more accurate emotion recognition.

### Step 4: Filtering of Voice. (See Step S4 in FIG. 11)

Filtering is performed on the voice data when a negative emotion is detected. In this step, a filtering unit on the server uses voice synthesis technology to adjust the tone, pitch, and speed of the voice, and converts it into a rational voice with suppressed emotional elements. For example, while maintaining the speaker's voice quality, the intonation of the voice can be flattened and the speed can be made constant in order to reduce the intensity of the emotion. Also, when a specific emotional phrase is detected, it is also possible to automatically replace that part. Furthermore, it provides an interface that allows the user to adjust the degree of filtering, and realizes voice output according to individual needs.

### Step 5: Omission or Summarization of Utterance. (See Step S5 in FIG. 11)

A negative utterance is omitted or summarized when it is determined to be irrelevant to the main thread of a discussion. In this step, a generation unit on the server analyzes the content of the utterance and evaluates its importance. Specific examples of prompt sentences to be read into the generative AI include, “Evaluate how relevant this utterance is to the purpose of the meeting, and summarize it if the relevance is low,” and “Extract the important points of this utterance and summarize them concisely.” The generative AI evaluates the importance by also performing a comparison with past meeting logs, in addition to the length of the utterance, the frequency of keyword appearance, and the relevance in the context. An utterance determined to have low importance is deleted from the voice or presented in a summarized form.

### Step 6: Output of Voice Data. (See Step S6 in FIG. 11)

The filtered and generated voice data is provided to the user. In this step, through the terminal's speaker or headset, the user can receive the voice with reduced stress. Furthermore, a user interface has a function to display the results of filtering and summarization in real time, and the user can provide feedback as needed. This makes it possible to effectively solve the problem of reduced work efficiency due to emotional voices and negative utterances in online calls.

### (Specific Use Case)

For example, a scene is assumed where a team working on an international project regularly checks progress through online meetings. This meeting includes members participating from different countries and regions, and there are language and cultural differences. During the meeting, a certain member begins to emotionally express dissatisfaction with a project delay. In such a situation, other members may be affected by the emotional utterance, the atmosphere of the meeting may worsen, and efficiency may decrease.

By using the system of the present disclosure, an acquisition unit acquires this emotional voice in real time, and a conversion unit converts the voice into text data. An emotion recognition unit analyzes the converted text data and detects a negative emotion. A filtering unit adjusts the tone and pitch of the voice and converts it into a rational voice with suppressed emotional elements. This allows other members to calmly continue the meeting.

Furthermore, when a generation unit determines that an emotional utterance is irrelevant to the main thread of a discussion, it omits or summarizes the utterance. Specific examples of prompt sentences to be read into the generative AI include, “Evaluate how relevant this utterance is to the progress of the project, and summarize it if the relevance is low,” and “Extract the important points of this utterance and summarize them concisely.”

An output unit provides the filtered and generated voice data to other members, allowing them to efficiently continue the discussion without interrupting the progress of the meeting. In this way, the system of the present disclosure can effectively solve the problem of reduced work efficiency due to emotional voices and negative utterances in online meetings, and contribute to the success of international projects.

### Application Example 1

A flow of specific processing in Application Example 1 will be described. Each unit of the system described below is realized by the data processing apparatus 12 and the smart device 14. Also, the data processing apparatus 12 is referred to as a “server”, and the smart device 14 is referred to as a “terminal”.

### Embodiment

An embodiment will be described in more specific and detailed terms. This embodiment is a communication support system in a nursing care facility, and aims to reduce emotional burden and provide better care by analyzing conversations between care staff and elderly people in real time.

First, an acquisition unit acquires conversations within a nursing care facility in real time. This acquisition unit collects voice data through microphones installed in the facility or wearable devices worn by care staff. For example, microphones installed in each room and common space of the facility pick up daily conversations. Also, a small microphone is built into a wearable device worn by care staff, making it possible to acquire voice even while moving. This allows a small microphone attached to a staff member's uniform to acquire voice when the care staff converses with an elderly person, enabling the collection of voice data throughout the entire facility.

Next, a conversion unit converts the acquired voice data into text data. This conversion unit analyzes a voice waveform using speech recognition technology, identifies phonemes, and converts the voice into a character string using a language model. For example, the speech recognition software supports multiple languages and dialects, and can also handle region-specific turns of phrase. This allows it to be used in international nursing care facilities and multicultural environments. Also, since it can convert voice to text in real time, it can perform processing without interrupting the flow of conversation. Furthermore, the speech recognition software is provided with a noise canceling function, and can remove background noise and accurately recognize a speaker's voice.

The converted text data is analyzed by an emotion recognition unit. This emotion recognition unit classifies emotions in the text into one of positive, neutral, and negative by fully utilizing natural language processing technology. For example, when an elderly person is feeling anxious or stressed, the emotion recognition AI can quickly detect that emotion. It comprehensively judges word choice, context, voice tone, and the like to accurately classify emotions. Also, by learning from past conversation data, it can grasp the emotional tendencies of a specific elderly person and realize more accurate emotion recognition. Furthermore, the emotion recognition unit also takes into consideration the frequency of use of pictograms and exclamation marks to determine emotions and performs more detailed emotion analysis.

When a negative emotion is detected, a filtering unit performs processing on the voice data. This filtering unit uses voice synthesis technology to adjust the tone and pitch of the voice and provides a rational and calm voice to the care staff. For example, so that the care staff can respond calmly to the elderly person, the intonation of the voice is flattened and converted to a gentle tone. Also, when a specific emotional phrase is detected, it is also possible to automatically replace that part. Furthermore, it provides an interface that allows the user to adjust the degree of filtering, and realizes voice output according to individual needs.

Furthermore, when an elderly person is feeling anxious, a generation unit generates a voice message that gives a sense of security. This generative AI analyzes the content of an utterance and generates a message for giving a sense of security. Specific examples of prompt sentences to be read into the generative AI include, “Please generate a message that an elderly person can feel secure with,” and “Please select gentle words to alleviate anxiety.” For example, messages such as “It's okay, we are here for you,” and “Please rest assured, we will help you right away” are generated. The generation unit can also generate more personalized messages based on past conversation data and the individual needs of the elderly person.

Finally, an output unit provides the filtered and generated voice to the care staff. The care staff can provide appropriate responses to the elderly person through these voices. For example, the care staff can use the generated message as is to give the elderly person a sense of security. This system makes it possible to improve the quality of communication in nursing care facilities, reduce the psychological burden on elderly people, and improve the work efficiency of care staff. Furthermore, the output unit is provided with a function to display the results of filtering and generation in real time, and the care staff can provide feedback as needed. This allows the system to be continuously improved and to realize more effective communication support.

### (System Configuration)

The system according to the present embodiment includes an acquisition unit, a conversion unit, an emotion recognition unit, a filtering unit, a generation unit, and an output unit. The acquisition unit is responsible for acquiring conversations within a nursing care facility in real time. This acquisition unit collects voice data through microphones installed in the facility or wearable devices worn by care staff. For example, microphones installed in each room and common space of the facility pick up daily conversations. Also, a small microphone is built into a wearable device worn by care staff, making it possible to acquire voice even while moving. This allows a small microphone attached to a staff member's uniform to acquire voice when the care staff converses with an elderly person, enabling the collection of voice data throughout the entire facility.

The conversion unit converts the acquired voice data into text data. This conversion unit analyzes a voice waveform using speech recognition technology, identifies phonemes, and converts the voice into a character string using a language model. For example, the speech recognition software supports multiple languages and dialects, and can also handle region-specific turns of phrase. This allows it to be used in international nursing care facilities and multicultural environments. Also, since it can convert voice to text in real time, it can perform processing without interrupting the flow of conversation. Furthermore, the speech recognition software is provided with a noise canceling function, and can remove background noise and accurately recognize a speaker's voice.

The emotion recognition unit analyzes the converted text data and classifies emotions by fully utilizing natural language processing technology. This emotion recognition unit classifies emotions in the text into one of positive, neutral, and negative. For example, when an elderly person is feeling anxious or stressed, the emotion recognition AI can quickly detect that emotion. It comprehensively judges word choice, context, voice tone, and the like to accurately classify emotions. Also, by learning from past conversation data, it can grasp the emotional tendencies of a specific elderly person and realize more accurate emotion recognition. Furthermore, the emotion recognition unit also takes into consideration the frequency of use of pictograms and exclamation marks to determine emotions and performs more detailed emotion analysis.

The filtering unit performs processing on the voice data when a negative emotion is detected. This filtering unit uses voice synthesis technology to adjust the tone and pitch of the voice and provides a rational and calm voice to the care staff. For example, so that the care staff can respond calmly to the elderly person, the intonation of the voice is flattened and converted to a gentle tone. Also, when a specific emotional phrase is detected, it is also possible to automatically replace that part. Furthermore, it provides an interface that allows the user to adjust the degree of filtering, and realizes voice output according to individual needs.

The generation unit generates a voice message that gives a sense of security when an elderly person is feeling anxious. This generative AI analyzes the content of an utterance and generates a message for giving a sense of security. Specific examples of prompt sentences to be read into the generative AI include, “Please generate a message that an elderly person can feel secure with,” and “Please select gentle words to alleviate anxiety.” For example, messages such as “It's okay, we are here for you,” and “Please rest assured, we will help you right away” are generated. The generation unit can also generate more personalized messages based on past conversation data and the individual needs of the elderly person.

The output unit provides the filtered and generated voice to the care staff. The care staff can provide appropriate responses to the elderly person through these voices. For example, the care staff can use the generated message as is to give the elderly person a sense of security. This system makes it possible to improve the quality of communication in nursing care facilities, reduce the psychological burden on elderly people, and improve the work efficiency of care staff. Furthermore, the output unit is provided with a function to display the results of filtering and generation in real time, and the care staff can provide feedback as needed. This allows the system to be continuously improved and to realize more effective communication support.

### (Implementation Steps)

Step 1: Acquisition of Voice Data. This is a step of acquiring conversations within a nursing care facility in real time. In this step, voice data is collected through microphones installed in the facility or wearable devices worn by care staff. For example, microphones installed in each room and common space of the facility pick up daily conversations. Also, a small microphone is built into a wearable device worn by care staff, making it possible to acquire voice even while moving. This allows a small microphone attached to a staff member's uniform to acquire voice when the care staff converses with an elderly person, enabling the collection of voice data throughout the entire facility.

Step 2: Conversion of Voice Data to Text. This is a step of converting the acquired voice data into text data. In this step, a voice waveform is analyzed using speech recognition technology, phonemes are identified, and the voice is converted into a character string using a language model. For example, the speech recognition software supports multiple languages and dialects, and can also handle region-specific turns of phrase. This allows it to be used in international nursing care facilities and multicultural environments. Also, since it can convert voice to text in real time, it can perform processing without interrupting the flow of conversation. Furthermore, the speech recognition software is provided with a noise canceling function, and can remove background noise and accurately recognize a speaker's voice.

Step 3: Classification of Emotions. This is a step of analyzing the converted text data and classifying emotions. In this step, emotions in the text are classified into one of positive, neutral, and negative by fully utilizing natural language processing technology. For example, when an elderly person is feeling anxious or stressed, the emotion recognition AI can quickly detect that emotion. It comprehensively judges word choice, context, voice tone, and the like to accurately classify emotions. Also, by learning from past conversation data, it can grasp the emotional tendencies of a specific elderly person and realize more accurate emotion recognition. Furthermore, the emotion recognition unit also takes into consideration the frequency of use of pictograms and exclamation marks to determine emotions and performs more detailed emotion analysis.

Step 4: Filtering of Voice. This is a step of performing filtering on the voice data when a negative emotion is detected. In this step, voice synthesis technology is used to adjust the tone and pitch of the voice and provide a rational and calm voice to the care staff. For example, so that the care staff can respond calmly to the elderly person, the intonation of the voice is flattened and converted to a gentle tone. Also, when a specific emotional phrase is detected, it is also possible to automatically replace that part. Furthermore, it provides an interface that allows the user to adjust the degree of filtering, and realizes voice output according to individual needs.

Step 5: Generation of Message Giving a Sense of Security. This is a step of generating a voice message that gives a sense of security when an elderly person is feeling anxious. In this step, a generative AI analyzes the content of an utterance and generates a message for giving a sense of security. Specific examples of prompt sentences to be read into the generative AI include, “Please generate a message that an elderly person can feel secure with,” and “Please select gentle words to alleviate anxiety.” For example, messages such as “It's okay, we are here for you,” and “Please rest assured, we will help you right away” are generated. The generation unit can also generate more personalized messages based on past conversation data and the individual needs of the elderly person.

Step 6: Output of Voice Data. This is a step of providing the filtered and generated voice data to the care staff. In this step, the care staff can provide appropriate responses to the elderly person through these voices. For example, the care staff can use the generated message as is to give the elderly person a sense of security. This system makes it possible to improve the quality of communication in nursing care facilities, reduce the psychological burden on elderly people, and improve the work efficiency of care staff. Furthermore, the output unit is provided with a function to display the results of filtering and generation in real time, and the care staff can provide feedback as needed. This allows the system to be continuously improved and to realize more effective communication support.

### (Specific Use Case)

For example, a scene is assumed where an elderly person with dementia routinely feels anxious in a certain nursing care facility. This elderly person's anxiety increases, particularly in the evening, and they often make emotional appeals to the care staff. In such a situation, the system of the present disclosure is introduced.

First, an acquisition unit acquires the conversation between the elderly person and the care staff in real time through a microphone installed in the facility. It can accurately capture the tone of voice and wording when the elderly person expresses anxiety. Next, a conversion unit converts the acquired voice data into text data. Using speech recognition technology, it analyzes the voice waveform, identifies phonemes, and converts the voice into a character string using a language model. This converts the elderly person's utterances into text, which then proceeds to the next process.

An emotion recognition unit analyzes the converted text data and classifies the elderly person's emotion. By fully utilizing natural language processing technology, it classifies the emotion in the text into one of positive, neutral, and negative. When the elderly person is feeling anxious, it quickly detects that emotion and notifies the care staff.

When a negative emotion is detected, a filtering unit performs processing on the voice data. Using voice synthesis technology, it adjusts the tone and pitch of the voice and provides a rational and calm voice to the care staff. This allows the care staff to respond calmly to the elderly person.

Furthermore, when an elderly person is feeling anxious, a generation unit generates a voice message that gives a sense of security. Specific examples of prompt sentences to be read into the generative AI include, “Please generate a message that an elderly person can feel secure with,” and “Please select gentle words to alleviate anxiety.” For example, messages such as “It's okay, we are here for you,” and “Please rest assured, we will help you right away” are generated. The generation unit can also generate more personalized messages based on past conversation data and the individual needs of the elderly person.

An output unit provides the filtered and generated voice to the care staff. The care staff can provide appropriate responses to the elderly person through these voices. For example, the care staff can use the generated message as is to give the elderly person a sense of security. This system makes it possible to improve the quality of communication in nursing care facilities, reduce the psychological burden on elderly people, and improve the work efficiency of care staff. Furthermore, the output unit is provided with a function to display the results of filtering and generation in real time, and the care staff can provide feedback as needed. This allows the system to be continuously improved and to realize more effective communication support.

The specific processing unit 290 transmits a result of the specific processing to the smart device 14. In the smart device 14, the control unit 46A causes the output device 40 to output the result of the specific processing. The microphone 38B acquires voice indicating a user input for the result of the specific processing. The control unit 46A transmits voice data indicating the user input acquired by the microphone 38B to the data processing apparatus 12. In the data processing apparatus 12, the specific processing unit 290 acquires the voice data.

The data generation model 58 is a so-called generative AI (Artificial Intelligence). An example of the data generation model 58 includes a generative AI such as ChatGPT (registered trademark) (Internet search <URL: https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specific processing unit 290 performs the above-described specific processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes AIs other than generative AI. AIs other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but the present disclosure is not limited to such examples. Also, the AI may be an AI agent. Also, when the processing of each unit described above is performed by an AI, the processing is partially or entirely performed by the AI, but the present disclosure is not limited to such an example. Also, a process implemented by an AI including a generative AI may be replaced with a rule-based process, and a rule-based process may be replaced with a process implemented by an AI including a generative AI.

Also, the processing by the data processing system 10 described above is executed by the specific processing unit 290 of the data processing apparatus 12 or the control unit 46A of the smart device 14, but may also be executed by the specific processing unit 290 of the data processing apparatus 12 and the control unit 46A of the smart device 14. Also, the specific processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using a generative AI. For example, a provision unit is realized by the output device 40 of the smart device 14 or the specific processing unit 290 of the data processing apparatus 12, and provides the generated cooking menu to a user. The correspondence relationship between each unit and the device or the control unit is not limited to the above-described example, and various changes are possible.

In the above embodiment, an example form in which the specific processing is performed by the data processing apparatus 12 has been described, but the technology of the present disclosure is not limited to this, and the specific processing may be performed by the smart device 14.

### Second Embodiment

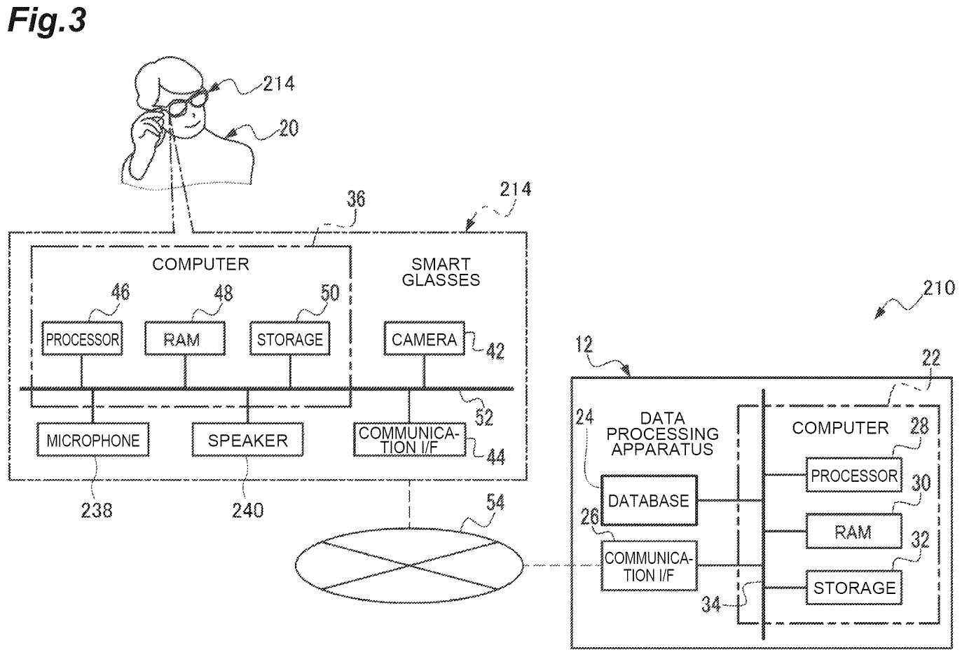

FIG. 3 illustrates an example of a configuration of a data processing system 210 according to a second embodiment.

As illustrated in FIG. 3, the data processing system 210 includes a data processing apparatus 12 and smart glasses 214. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The smart glasses 214 include a computer 36, a microphone 238, a speaker 240, a camera 42, and a communication I/F 44. The computer 36 includes a processor 46, a RAM 48, and a storage 50. The processor 46, the RAM 48, and the storage 50 are connected to a bus 52. Also, the microphone 238, the speaker 240, and the camera 42 are also connected to the bus 52.

The microphone 238 receives an instruction or the like from a user 20 by receiving voice uttered by the user 20. The microphone 238 captures the voice uttered by the user 20, converts the captured voice into voice data, and outputs the voice data to the processor 46. The speaker 240 outputs voice in accordance with an instruction from the processor 46.

The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted, and images the surroundings of the user 20 (for example, an imaging range defined by an angle of view corresponding to the width of the field of view of a general person with normal vision).

The communication I/F 44 is connected to the network 54. The communication I/Fs 44 and 26 manage exchange of various information between the processor 46 and the processor 28 via the network 54. The exchange of various information between the processor 46 and the processor 28 using the communication I/Fs 44 and 26 is performed in a secure state.

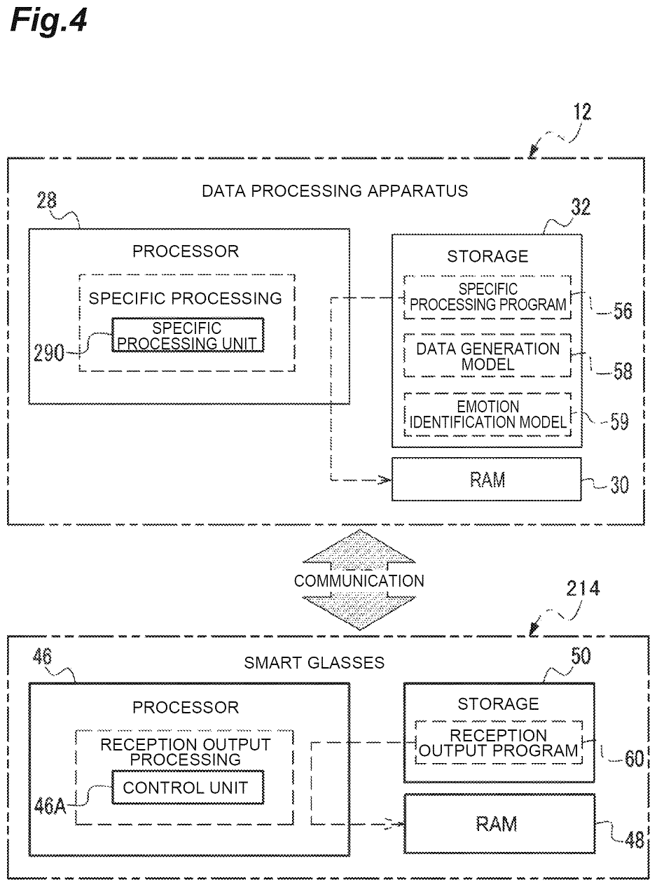

FIG. 4 illustrates an example of main functions of the data processing apparatus 12 and the smart glasses 214. As illustrated in FIG. 4, in the data processing apparatus 12, specific processing is performed by the processor 28. A specific processing program 56 is stored in the storage 32.

The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as a specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290. The specific processing unit 290 can estimate a user's emotion using the emotion identification model 59 and perform specific processing using the user's emotion. In an emotion estimation function (emotion identification function) using the emotion identification model 59, various estimations and predictions regarding the user's emotion, including estimation and prediction of the user's emotion, are performed, but the present disclosure is not limited to such an example. Also, the estimation and prediction of emotion include, for example, analysis (analytics) of emotion and the like.

In the smart glasses 214, reception output processing is performed by the processor 46. A reception output program 60 is stored in the storage 50. The processor 46 reads the reception output program 60 from the storage 50 and executes the read reception output program 60 on the RAM 48. The reception output processing is realized by the processor 46 operating as a control unit 46A in accordance with the reception output program 60 executed on the RAM 48. Note that the smart glasses 214 can also have a data generation model and an emotion identification model similar to the data generation model 58 and the emotion identification model 59, and perform processing similar to that of the specific processing unit 290 using these models.

Next, specific processing by the specific processing unit 290 of the data processing apparatus 12 will be described. Each unit of the system described below is realized by the data processing apparatus 12 and the smart glasses 214. In the following description, the data processing apparatus 12 is referred to as a “server”, and the smart glasses 214 are referred to as a “terminal”.

### Example 1

Since the flow of the specific processing is the same as that in Example 1 described in the first embodiment, a description thereof is omitted.

### Application Example 1

Since the flow of the specific processing is the same as that in Example 1 described in the first embodiment, a description thereof is omitted.

The specific processing unit 290 transmits a result of the specific processing to the smart glasses 214. In the smart glasses 214, the control unit 46A causes the speaker 240 to output the result of the specific processing. The microphone 238 acquires voice indicating a user input for the result of the specific processing. The control unit 46A transmits voice data indicating the user input acquired by the microphone 238 to the data processing apparatus 12. In the data processing apparatus 12, the specific processing unit 290 acquires the voice data.

The data generation model 58 is a so-called generative AI (Artificial Intelligence). An example of the data generation model 58 includes a generative AI such as ChatGPT (registered trademark) (Internet search <URL: https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specific processing unit 290 performs the above-described specific processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes AIs other than generative AI. AIs other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but the present disclosure is not limited to such examples. Also, the AI may be an AI agent. Also, when the processing of each unit described above is performed by an AI, the processing is partially or entirely performed by the AI, but the present disclosure is not limited to such an example. Also, a process implemented by an AI including a generative AI may be replaced with a rule-based process, and a rule-based process may be replaced with a process implemented by an AI including a generative AI.

Also, the processing by the data processing system 10 described above is executed by the specific processing unit 290 of the data processing apparatus 12 or the control unit 46A of the smart device 14, but may also be executed by the specific processing unit 290 of the data processing apparatus 12 and the control unit 46A of the smart device 14. Also, the specific processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using a generative AI. For example, a provision unit is realized by the output device 40 of the smart device 14 or the specific processing unit 290 of the data processing apparatus 12, and provides the generated cooking menu to a user. The correspondence relationship between each unit and the device or the control unit is not limited to the above-described example, and various changes are possible.

In the above embodiment, an example form in which the specific processing is performed by the data processing apparatus 12 has been described, but the technology of the present disclosure is not limited to this, and the specific processing may be performed by the smart glasses 214.

### Third Embodiment

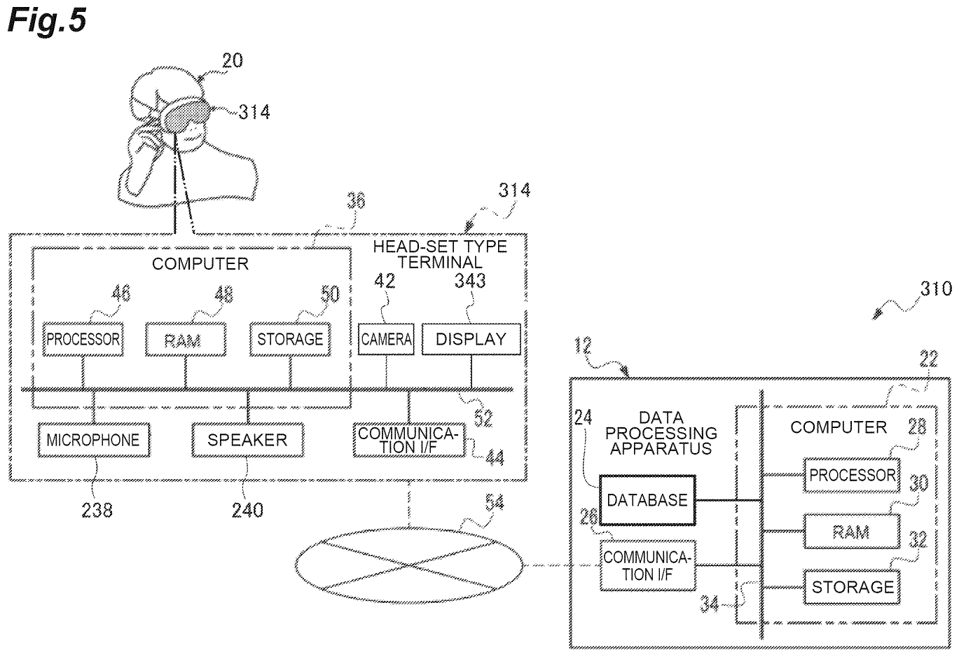

FIG. 5 illustrates an example of a configuration of a data processing system 310 according to a third embodiment.

As illustrated in FIG. 5, the data processing system 310 includes a data processing apparatus 12 and a headset-type terminal 314. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The headset-type terminal 314 includes a computer 36, a microphone 238, a speaker 240, a camera 42, a communication I/F 44, and a display 343. The computer 36 includes a processor 46, a RAM 48, and a storage 50. The processor 46, the RAM 48, and the storage 50 are connected to a bus 52. Also, the microphone 238, the speaker 240, the camera 42, and the display 343 are also connected to the bus 52.

The microphone 238 receives an instruction or the like from a user 20 by receiving voice uttered by the user 20. The microphone 238 captures the voice uttered by the user 20, converts the captured voice into voice data, and outputs the voice data to the processor 46. The speaker 240 outputs voice in accordance with an instruction from the processor 46.

The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted, and images the surroundings of the user 20 (for example, an imaging range defined by an angle of view corresponding to the width of the field of view of a general person with normal vision).

The communication I/F 44 is connected to the network 54. The communication I/Fs 44 and 26 manage exchange of various information between the processor 46 and the processor 28 via the network 54. The exchange of various information between the processor 46 and the processor 28 using the communication I/Fs 44 and 26 is performed in a secure state.

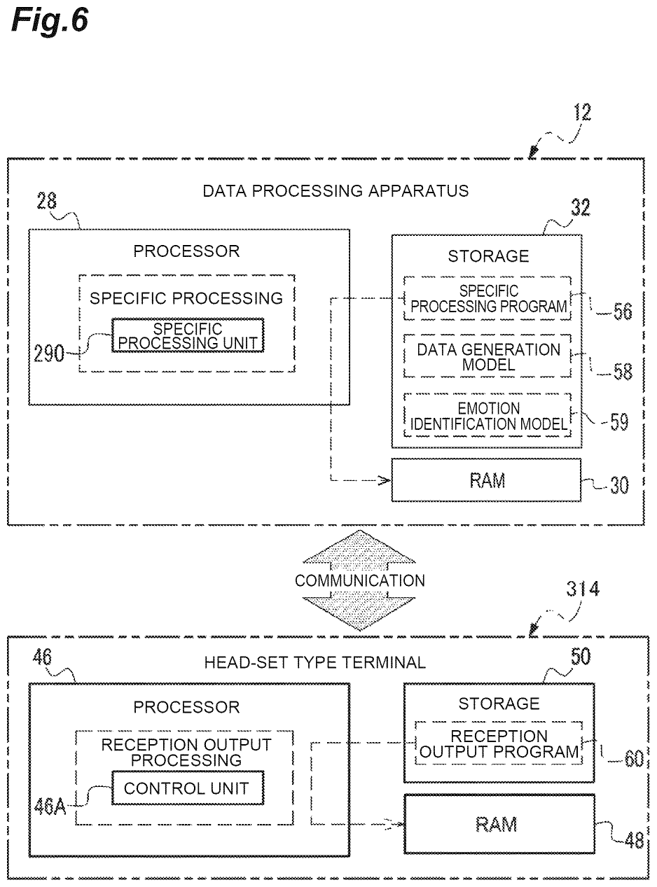

FIG. 6 illustrates an example of main functions of the data processing apparatus 12 and the headset-type terminal 314. As illustrated in FIG. 6, in the data processing apparatus 12, specific processing is performed by the processor 28. A specific processing program 56 is stored in the storage 32.

The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as a specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290.

In the headset-type terminal 314, reception output processing is performed by the processor 46. A reception output program 60 is stored in the storage 50. The processor 46 reads the reception output program 60 from the storage 50 and executes the read reception output program 60 on the RAM 48. The reception output processing is realized by the processor 46 operating as a control unit 46A in accordance with the reception output program 60 executed on the RAM 48.

Next, specific processing by the specific processing unit 290 of the data processing apparatus 12 will be described. Each unit of the system described below is realized by the data processing apparatus 12 and the headset-type terminal 314. In the following description, the data processing apparatus 12 is referred to as a “server”, and the headset-type terminal 314 is referred to as a “terminal”.

### Example 1

Since the flow of the specific processing is the same as that in Example 1 described in the first embodiment, a description thereof is omitted.

### Application Example 1

Since the flow of the specific processing is the same as that in Example 1 described in the first embodiment, a description thereof is omitted.

The specific processing unit 290 transmits a result of the specific processing to the headset-type terminal 314. In the headset-type terminal 314, the control unit 46A causes the speaker 240 and the display 343 to output the result of the specific processing. The microphone 238 acquires voice indicating a user input for the result of the specific processing. The control unit 46A transmits voice data indicating the user input acquired by the microphone 238 to the data processing apparatus 12. In the data processing apparatus 12, the specific processing unit 290 acquires the voice data.

The data generation model 58 is a so-called generative AI (Artificial Intelligence). An example of the data generation model 58 includes a generative AI such as ChatGPT (registered trademark) (Internet search <URL: https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specific processing unit 290 performs the above-described specific processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes AIs other than generative AI. AIs other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but the present disclosure is not limited to such examples. Also, the AI may be an AI agent. Also, when the processing of each unit described above is performed by an AI, the processing is partially or entirely performed by the AI, but the present disclosure is not limited to such an example. Also, a process implemented by an AI including a generative AI may be replaced with a rule-based process, and a rule-based process may be replaced with a process implemented by an AI including a generative AI.

Also, the processing by the data processing system 10 described above is executed by the specific processing unit 290 of the data processing apparatus 12 or the control unit 46A of the smart device 14, but may also be executed by the specific processing unit 290 of the data processing apparatus 12 and the control unit 46A of the smart device 14. Also, the specific processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using a generative AI. For example, a provision unit is realized by the output device 40 of the smart device 14 or the specific processing unit 290 of the data processing apparatus 12, and provides the generated cooking menu to a user. The correspondence relationship between each unit and the device or the control unit is not limited to the above-described example, and various changes are possible.

In the above embodiment, an example form in which the specific processing is performed by the data processing apparatus 12 has been described, but the technology of the present disclosure is not limited to this, and the specific processing may be performed by the headset-type terminal 314.

### Fourth Embodiment

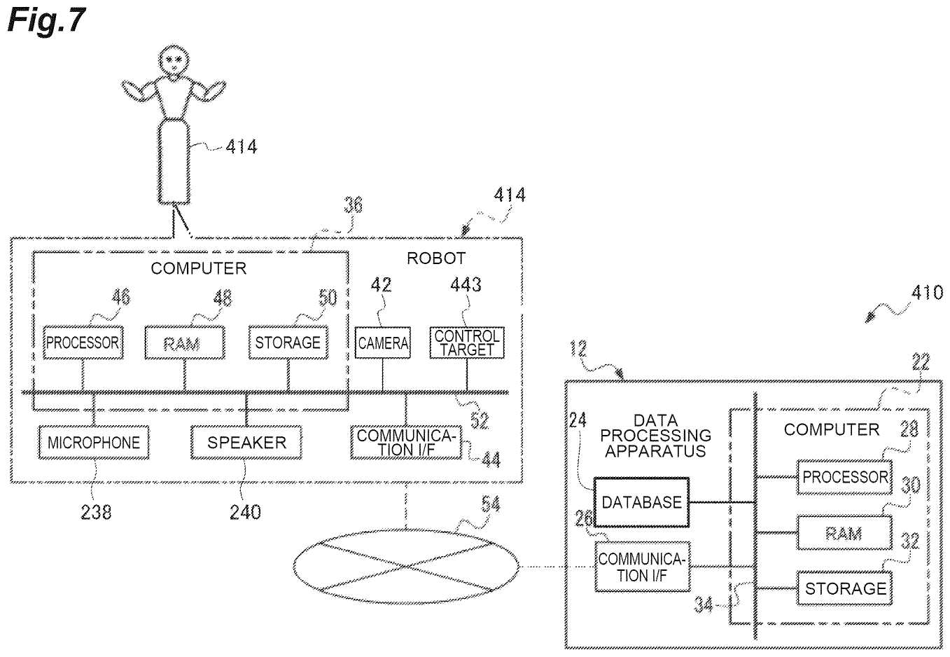

FIG. 7 illustrates an example of a configuration of a data processing system 410 according to a fourth embodiment.

As illustrated in FIG. 7, the data processing system 410 includes a data processing apparatus 12 and a robot 414. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The robot 414 includes a computer 36, a microphone 238, a speaker 240, a camera 42, a communication I/F 44, and a control target 443. The computer 36 includes a processor 46, a RAM 48, and a storage 50. The processor 46, the RAM 48, and the storage 50 are connected to a bus 52. Also, the microphone 238, the speaker 240, the camera 42, and the control target 443 are also connected to the bus 52.

The microphone 238 receives an instruction or the like from a user 20 by receiving voice uttered by the user 20. The microphone 238 captures the voice uttered by the user 20, converts the captured voice into voice data, and outputs the voice data to the processor 46. The speaker 240 outputs voice in accordance with an instruction from the processor 46.

The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted, and images the surroundings of the user 20 (for example, an imaging range defined by an angle of view corresponding to the width of the field of view of a general person with normal vision).

The communication I/F 44 is connected to the network 54. The communication I/Fs 44 and 26 manage exchange of various information between the processor 46 and the processor 28 via the network 54. The exchange of various information between the processor 46 and the processor 28 using the communication I/Fs 44 and 26 is performed in a secure state.

The control target 443 includes a display device, an LED of an eye part, and motors that drive an arm, a hand, a leg, and the like. The posture and gestures of the robot 414 are controlled by controlling the motors of the arm, hand, leg, and the like. A part of the emotions of the robot 414 can be expressed by controlling these motors. Also, the facial expression of the robot 414 can also be expressed by controlling the light emission state of the LED of the eye part of the robot 414.

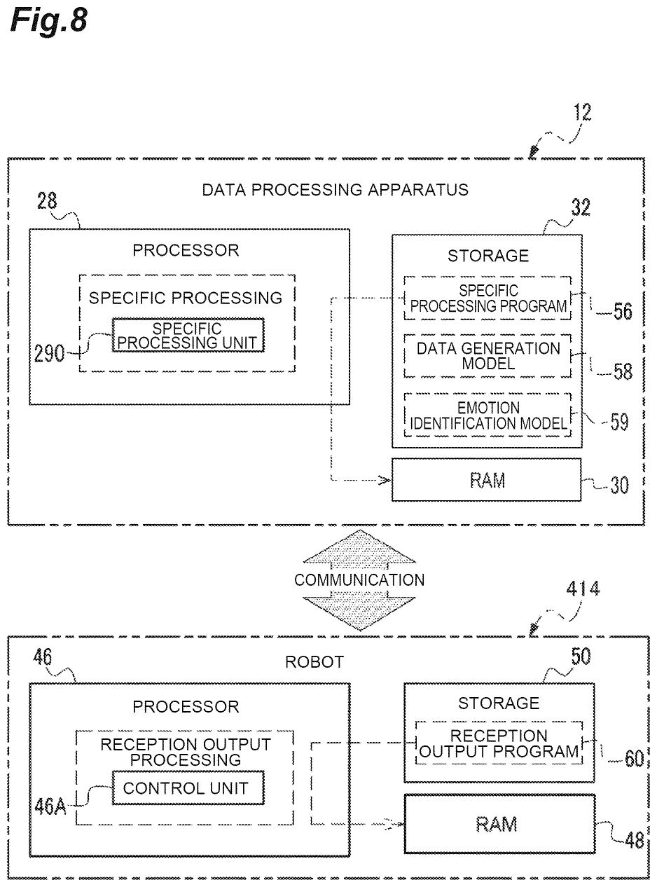

FIG. 8 illustrates an example of main functions of the data processing apparatus 12 and the robot 414. As illustrated in FIG. 8, in the data processing apparatus 12, specific processing is performed by the processor 28. A specific processing program 56 is stored in the storage 32.

The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as a specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290.

In the robot 414, reception output processing is performed by the processor 46. A reception output program 60 is stored in the storage 50. The processor 46 reads the reception output program 60 from the storage 50 and executes the read reception output program 60 on the RAM 48. The reception output processing is realized by the processor 46 operating as a control unit 46A in accordance with the reception output program 60 executed on the RAM 48.

Next, specific processing by the specific processing unit 290 of the data processing apparatus 12 will be described. Each unit of the system described below is realized by the data processing apparatus 12 and the robot 414. In the following description, the data processing apparatus 12 is referred to as a “server”, and the robot 414 is referred to as a “terminal”.

### Example 1

Since the flow of the specific processing is the same as that in Example 1 described in the first embodiment, a description thereof is omitted.

### Application Example 1

Since the flow of the specific processing is the same as that in Example 1 described in the first embodiment, a description thereof is omitted.

The specific processing unit 290 transmits a result of the specific processing to the robot 414. In the robot 414, the control unit 46A causes the speaker 240 and the control target 443 to output the result of the specific processing. The microphone 238 acquires voice indicating a user input for the result of the specific processing. The control unit 46A transmits voice data indicating the user input acquired by the microphone 238 to the data processing apparatus 12. In the data processing apparatus 12, the specific processing unit 290 acquires the voice data.

The data generation model 58 is a so-called generative AI (Artificial Intelligence). An example of the data generation model 58 includes a generative AI such as ChatGPT (registered trademark) (Internet search <URL: https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specific processing unit 290 performs the above-described specific processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes AIs other than generative AI. AIs other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but the present disclosure is not limited to such examples. Also, the AI may be an AI agent. Also, when the processing of each unit described above is performed by an AI, the processing is partially or entirely performed by the AI, but the present disclosure is not limited to such an example. Also, a process implemented by an AI including a generative AI may be replaced with a rule-based process, and a rule-based process may be replaced with a process implemented by an AI including a generative AI.

Also, the processing by the data processing system 10 described above is executed by the specific processing unit 290 of the data processing apparatus 12 or the control unit 46A of the smart device 14, but may also be executed by the specific processing unit 290 of the data processing apparatus 12 and the control unit 46A of the smart device 14. Also, the specific processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using a generative AI. For example, a provision unit is realized by the output device 40 of the smart device 14 or the specific processing unit 290 of the data processing apparatus 12, and provides the generated cooking menu to a user. The correspondence relationship between each unit and the device or the control unit is not limited to the above-described example, and various changes are possible.

In the above embodiment, an example form in which the specific processing is performed by the data processing apparatus 12 has been described, but the technology of the present disclosure is not limited to this, and the specific processing may be performed by the robot 414.

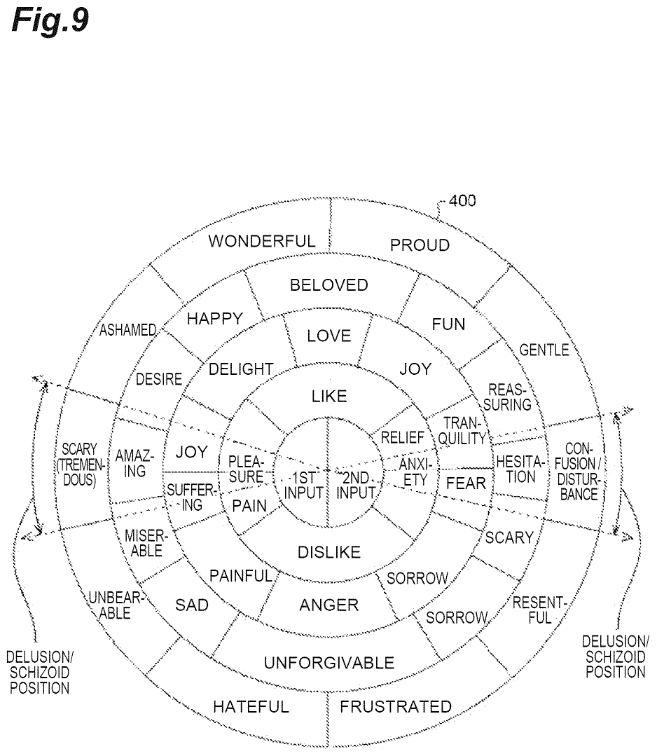

Note that the emotion identification model 59 as an emotion engine may determine a user's emotion according to a specific mapping. Specifically, the emotion identification model 59 may determine the user's emotion according to an emotion map (see FIG. 9), which is a specific mapping. Also, the emotion identification model 59 may similarly determine the robot's emotion, and the specific processing unit 290 may perform specific processing using the robot's emotion.

FIG. 9 is a diagram illustrating an emotion map 400 on which a plurality of emotions are mapped. In the emotion map 400, emotions are arranged in concentric circles radiating from the center. The closer to the center of the concentric circles, the more primitive the state of the emotion is arranged. On the outer side of the concentric circles, emotions representing states and actions arising from a state of mind are arranged. Emotion is a concept that also includes affect and mental states. On the left side of the concentric circles, emotions generated from reactions that generally occur in the brain are arranged. On the right side of the concentric circles, emotions that are generally induced by situational judgment are arranged. In the upward and downward directions of the concentric circles, emotions that are generated from reactions that generally occur in the brain and are induced by situational judgment are arranged. Also, on the upper side of the concentric circles, “pleasant” emotions are arranged, and on the lower side, “unpleasant” emotions are arranged. In this way, in the emotion map 400, a plurality of emotions are mapped based on the structure in which emotions are generated, and emotions that are likely to occur at the same time are mapped close to each other.

These emotions are distributed in the 3 o'clock direction of the emotion map 400, and usually go back and forth between relief and anxiety. In the right half of the emotion map 400, situational awareness is superior to internal sensations, resulting in a calm impression.

Since the inside of the emotion map 400 represents the inside of the mind and the outside of the emotion map 400 represents actions, the further one goes to the outside of the emotion map 400, the more visible (manifested in action) the emotion becomes.

Here, human emotions are based on various balances such as posture and blood sugar levels, and show a state of unpleasantness when those balances move away from the ideal, and a state of pleasantness when they approach the ideal. In robots, automobiles, motorcycles, and the like as well, emotions can be created based on various balances such as posture and remaining battery level, so as to show a state of unpleasantness when those balances move away from the ideal, and a state of pleasantness when they approach the ideal. The emotion map may be generated based on, for example, Dr. Mitsuyoshi's emotion map (Research on a speech emotion recognition and brain physiological signal analysis system of affect, Tokushima University, doctoral dissertation: https://ci.nii.ac.jp/naid/500000375379). In the left half of the emotion map, emotions belonging to a region called “reaction” where sensation is dominant are arranged. Also, in the right half of the emotion map, emotions belonging to a region called “situation” where situational awareness is dominant are arranged.

In the emotion map, two emotions that promote learning are defined. One is an emotion around the middle of negative “remorse” and “reflection” on the situation side. That is, it is when a negative emotion such as “I never want to feel this way again” or “I don't want to be scolded anymore” arises in the robot. The other is an emotion around positive “desire” on the reaction side. That is, it is when there is a positive feeling such as “I want more” or “I want to know more”.

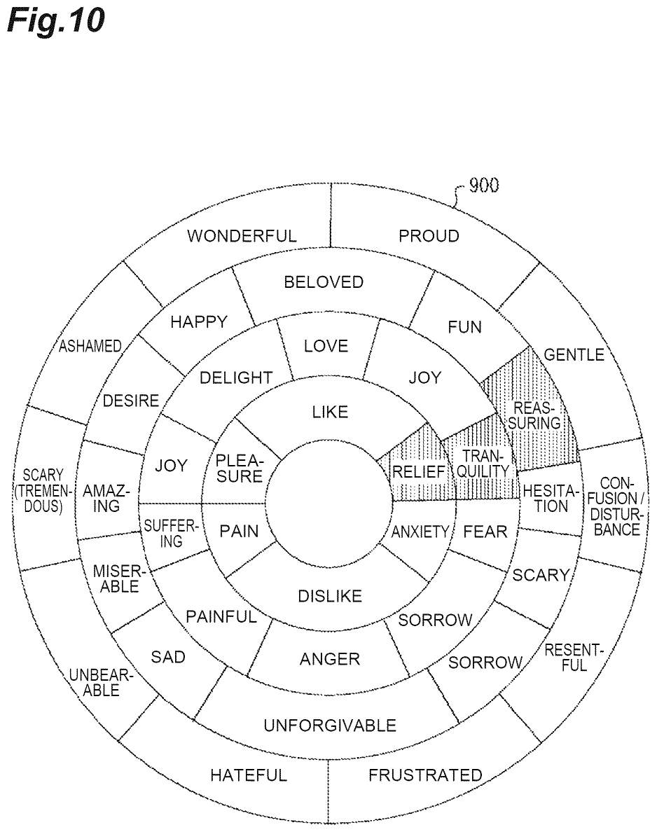

The emotion identification model 59 inputs a user input into a pre-trained neural network, acquires an emotion value indicating each emotion shown in the emotion map 400, and determines the user's emotion. This neural network is pre-trained based on a plurality of learning data that are combinations of user inputs and emotion values indicating each emotion shown in the emotion map 400. Also, this neural network is trained such that emotions arranged close to each other have close values, as in the emotion map 900 shown in FIG. 10. FIG. 10 shows an example in which a plurality of emotions, “relief,” “peace of mind,” and “reassured,” have close emotion values.

Although the system according to the present disclosure has been described above mainly with respect to the functions of the data processing apparatus 12, the system according to the present disclosure is not necessarily implemented in a server. The system according to the present disclosure may be implemented as a general information processing system. The present disclosure may be implemented as, for example, a software program that runs on a personal computer, or an application that runs on a smartphone or the like. The method according to the present disclosure may be provided to a user in a Saas (Software as a Service) format.

In the above embodiment, an example form in which the specific processing is performed by one computer 22 has been described, but the technology of the present disclosure is not limited to this, and distributed processing for the specific processing may be performed by a plurality of computers including the computer 22. For example, the data generation model 58 may be provided in an external device of the data processing apparatus 12, and the external device may generate data according to the input data.

In the above embodiment, an example form in which the specific processing program 56 is stored in the storage 32 has been described, but the technology of the present disclosure is not limited to this. For example, the specific processing program 56 may be stored in a portable computer-readable non-transitory storage medium such as a USB (Universal Serial Bus) memory. The specific processing program 56 stored in the non-transitory storage medium is installed in the computer 22 of the data processing apparatus 12. The processor 28 executes the specific processing according to the specific processing program 56.

Also, the specific processing program 56 may be stored in a storage device such as a server connected to the data processing apparatus 12 via the network 54, and the specific processing program 56 may be downloaded in response to a request from the data processing apparatus 12 and installed in the computer 22.

Note that it is not necessary to store all of the specific processing program 56 in a storage device such as a server connected to the data processing apparatus 12 via the network 54, or to store all of the specific processing program 56 in the storage 32, and a part of the specific processing program 56 may be stored.

As hardware resources for executing the specific processing, various processors shown below can be used. Examples of the processor include a CPU, which is a general-purpose processor that functions as a hardware resource for executing the specific processing by executing software, that is, a program. Also, examples of the processor include a dedicated electric circuit, which is a processor having a circuit configuration specifically designed to execute specific processing, such as an FPGA (Field-Programmable Gate Array), a PLD (Programmable Logic Device), or an ASIC (Application Specific Integrated Circuit). A memory is built in or connected to any of the processors, and any of the processors executes the specific processing by using the memory.

The hardware resource that executes the specific processing may be configured by one of these various processors, or may be configured by a combination of two or more processors of the same type or different types (for example, a combination of a plurality of FPGAs, or a combination of a CPU and an FPGA). Also, the hardware resource that executes the specific processing may be one processor.

As an example of a configuration with one processor, first, there is a form in which one processor is configured by a combination of one or more CPUs and software, and this processor functions as a hardware resource for executing the specific processing. Second, there is a form in which a processor that realizes the functions of an entire system including a plurality of hardware resources for executing the specific processing with one IC chip, as represented by an SoC (System-on-a-chip) or the like, is used. In this way, the specific processing is realized using one or more of the various processors described above as hardware resources.

Furthermore, as a hardware structure of these various processors, more specifically, an electric circuit in which circuit elements such as semiconductor elements are combined can be used. Also, the specific processing described above is merely an example. Therefore, it goes without saying that unnecessary steps may be deleted, new steps may be added, or the processing order may be changed within a scope that does not depart from the gist.

The description and illustrations shown above are detailed descriptions of the parts related to the technology of the present disclosure, and are merely an example of the technology of the present disclosure. For example, the description regarding the above-described configuration, function, operation, and effect is a description regarding an example of the configuration, function, operation, and effect of the part related to the technology of the present disclosure. Therefore, it goes without saying that unnecessary parts may be deleted, new elements may be added, or replacements may be made to the description and illustrations shown above within a scope that does not depart from the gist of the technology of the present disclosure. Also, in order to avoid confusion and facilitate understanding of the parts related to the technology of the present disclosure, in the description and illustrations shown above, descriptions regarding common general technical knowledge and the like that do not require particular explanation for enabling the implementation of the technology of the present disclosure are omitted.

All documents, patent applications, and technical standards described in this specification are incorporated herein by reference to the same extent as if each individual document, patent application, and technical standard were specifically and individually indicated to be incorporated by reference.

Regarding the above embodiments, the following is further disclosed.

### Application Example 1

A system comprising an acquisition unit, a conversion unit, an emotion recognition unit, a filtering unit, a generation unit, and an output unit. The acquisition unit acquires conversations within a nursing care facility in real time, and the conversion unit converts the acquired voice data into text data using speech recognition technology. The emotion recognition unit analyzes the converted text data and classifies emotions into one of positive, neutral, and negative by fully utilizing natural language processing technology. The filtering unit, when a negative emotion is detected, adjusts the tone, pitch, and speed of the voice using voice synthesis technology and converts it into a rational voice with suppressed emotional elements. The generation unit generates a voice message that gives a sense of security when an elderly person is feeling anxious, and the output unit provides the filtered and generated voice to care staff.

The system, wherein the acquisition unit collects voice data through microphones installed in the nursing care facility or wearable devices worn by care staff, and the conversion unit analyzes a voice waveform, identifies phonemes, and converts the voice into a character string using a language model. This makes it possible to support multiple languages and dialects, and also to handle region-specific turns of phrase, and since voice can be converted to text in real time, processing can be performed without interrupting the flow of conversation.

The system, wherein the emotion recognition unit determines emotions by taking into consideration word choice, context, grammatical structure, and even the frequency of use of pictograms and exclamation marks, and the filtering unit, while maintaining the speaker's voice quality, flattens the intonation of the voice and makes the speed constant in order to reduce the intensity of the emotion. Furthermore, the generation unit analyzes the content of an utterance, generates a message for giving a sense of security, and uses “Please generate a message that an elderly person can feel secure with” and “Please select gentle words to alleviate anxiety” as prompt sentences to be read into a generative AI.

An emotion filtering system, comprising: circuitry, wherein the circuitry is configured to: acquire voice data; convert the acquired voice data into text data; analyze the converted text data to classify an emotion; filter the voice data based on the classified emotion and convert the voice data into a rational voice; when a negative utterance is detected and the utterance is irrelevant to a main thread of a discussion, omit or summarize the utterance; and output the omitted or summarized voice.

The emotion filtering system, wherein the circuitry is configured to: acquire the voice data in real time; convert the voice data into the text data using speech recognition technology; and analyze the converted text data using natural language processing technology to classify the emotion into one of positive, neutral, and negative.

The emotion filtering system, wherein the circuitry is configured to: when the negative emotion is detected, adjust a tone, a pitch, and a speed of the voice and convert it into the rational voice with suppressed emotional elements; and when it is determined that the negative utterance is irrelevant to the main thread of the discussion, omit or summarize the negative utterance using a generative AI.

An emotion filtering method, comprising: acquiring voice data; converting the acquired voice data into text data; analyzing the converted text data to classify an emotion; filtering the voice data based on the classified emotion and converting it into a rational voice; when a negative utterance is detected and the utterance is irrelevant to a main thread of a discussion, omitting or summarizing the utterance; and outputting the omitted or summarized voice.

1. An emotion filtering system, comprising:
circuitry,
wherein the circuitry is configured to:
acquire voice data;
convert the acquired voice data into text data;
analyze the converted text data to classify an emotion;
filter the voice data based on the classified emotion and convert the voice data into a rational voice;
when a negative utterance is detected and the utterance is irrelevant to a main thread of a discussion, omit or summarize the utterance; and
output the omitted or summarized voice.

2. The emotion filtering system according to claim 1, wherein the circuitry is configured to:
acquire the voice data in real time;
convert the voice data into the text data using speech recognition technology; and
analyze the converted text data using natural language processing technology to classify the emotion into one of positive, neutral, and negative.

3. The emotion filtering system according to claim 1, wherein the circuitry is configured to:
when the negative emotion is detected, adjust a tone, a pitch, and a speed of the voice and convert it into the rational voice with suppressed emotional elements; and
when it is determined that the negative utterance is irrelevant to the main thread of the discussion, omit or summarize the negative utterance using a generative AI.

4. An emotion filtering method, comprising:
acquiring voice data;
converting the acquired voice data into text data;
analyzing the converted text data to classify an emotion;
filtering the voice data based on the classified emotion and converting it into a rational voice;
when a negative utterance is detected and the utterance is irrelevant to a main thread of a discussion, omitting or summarizing the utterance; and
outputting the omitted or summarized voice.
